(19) United States
(12) Patent Application Publication
(10) Pub. No.: US 2008/0232908 A1
(43) Pub. Date: Sep. 25, 2008

(54) Pneumatic Cartridge

(76) Inventors: Jean Laffay, Pelissanne (FR); Morad Addou, Eyguieres (FR)

Correspondence Address: Horst M. Kasper, 13 Forest Drive, Warren, NJ, 07059, US

(21) Appl. No.: 11/794,393

(22) PCT Filed: Dec. 21, 2005
(86) PCT No.: PCT/FR05/03242

§ 371 Date: Apr. 14, 2008

(30) Foreign Application Priority Data
Dec. 24, 2004 (FR) 0413900

(51) Int. Cl. B65G 51/06

(52) U.S. Cl. 406/184

(57) ABSTRACT

The invention relates to a pneumatic cartridge CA that is constituted by a cylinder CY provided with two endpieces and having at least one opening. The cartridge has at least one automatically-closing transfer device CH1, CH2, TR provided to disengage the opening completely. Furthermore, the automatically-closing transfer device is arranged at one of the ends of the cartridge.

The present invention relates to a cartridge and to a pneumatic network for conveying the cartridge. Cartridges are conveyed via a network of pipes that serves to interconnect workstations, a storage center, and a surrender station. In addition, a suck and blow circuit is fitted to the network.

The invention applies to any type of pneumatic conveyor system, in particular for transporting money of the kind that is performed in highway tolls, large stores, banks, or casinos. It also applies to any other transport system making use of cartridges entrained by a flow of air.

One such conveyor network is described in document FR 2 803 584. That network relates to a highway toll station that serves to transport cash pneumatically. The cash is initially inserted into the cartridges at the toll stations that constitute the workstations. It should be emphasized that such workstations are subjected to a high risk of burglary.

The cartridges are then taken to a secure surrender station, often situated in an armored strong room. Furthermore, a storage center that is also connected to the network serves to receive and deliver empty cartridges. A turbine associated with a flow-varying unit serves to raise or lower the pressure of the air contained in the pipes constituting the conveyor network between the workstations, the surrender station, and the storage center. The turbine thus serves to move the cartridges.

Switchers, analogous to rail switches, serve to direct a cartridge from one location to another. Initially, the cartridge is sucked from its starting point towards a switcher, and subsequently it is blown from the switcher towards its destination location.

The cartridges are all in the form of transparent plastics cylinders having each end provided with an opaque plastics endpiece. The endpieces are provided with access lids. These lids pivot about respective axes that coincide substantially with a generator line of the envelope of the cylinder. This enables the opening in the cylinder to be completely disengaged.

Both endpieces are surrounded by respective bands of material that comes into contact with the inside walls of the pipes. These bands make it easier for the cartridges to slide while they are moving. Because the diameter of the cylinder is smaller than the diameter of its two endpieces, the cartridge can easily pass through bends that are present in the pipes. The first lid is held closed by return means such as a spring that presses it against a bearing cornice formed in the thickness of the endpiece. There is therefore no risk of it opening ajar while in transit. The second lid is optionally hinged about a generator line diametrically opposite to the first hinge.

When a toll collector seeks to send money from a workstation to the surrender station, the collector opens one of the lids of the cartridge, inserts the cash, and recloses the lid. After ensuring that the cartridge is properly positioned in the loading station located at the end of the pipe leading to the workstation, the collector causes the full cartridge to be sent towards the surrender station.

Initially, the turbine and the flow-varying unit establish suction that sucks the cartridge from the workstation towards a switcher. Thereafter, the turbine and the flow-varying unit increase air pressure so as to blow the cartridge from the switcher towards the surrender station. On reaching that location, the cartridge drops into a receptacle. It can then be emptied and stored in a suitable location.

When a toll collector is short of empty cartridges, the collector operates a control for causing an empty cartridge to be delivered from the storage center to the workstation. This control may be made automatic.

Initially, the turbine and the flow-varying unit establish suction that sucks the cartridge from the storage center to the switcher. Thereafter, the turbine and the flow-varying unit increase the pressure of the air so as to blow the cartridge from the switcher to the workstation.

A similar path can be followed by empty cartridges between the surrender station and the switcher, and then between the switcher and the storage center.

Cartridges do not travel between the switcher and the turbine. The pipe between the turbine and the switcher serves solely to raise or lower the pressure of the air in the pipes followed by the cartridges.

Such a device presents a certain number of limitations at a workstation.

Firstly, when a toll collector seeks to send cash to the surrender station, it is necessary to take care not to forget to close the lid of the cartridge before inserting the cartridge into the loading station.

Thereafter, highway operator companies desire vehicles to pass through tolls quickly. The operation of loading cartridges causes the vehicles passing through the toll station in question to wait because the toll collector is otherwise engaged. The time taken to perform this operation penalizes road traffic.

Furthermore, there are more and more automatic tolls on highways. To convey cash from workstations to the surrender station, it is necessary for staff to visit the toll stations and fill the cash into cartridges. Traffic can be interrupted and staff might be attacked.

There is thus clearly a need to automate the filling of cartridges, regardless of whether they are for transporting cash or any other articles.

On this topic, U.S. Pat. No. 4,620,577 teaches a cartridge provided with a transfer device that releases a cartridge filler opening when it is activated, and that recloses the opening automatically. The opening is fully disengaged on the device being actuated, which is essential in certain applications. When the opening remains partially obstructed by the device, the size of the articles that can be inserted into the cartridge is severely limited.

Nevertheless, since the transfer device is inside the cartridge, it is difficult to make. The cartridge is made by assembling together two half-shells after the device has been mounted in one of the half-shells. Furthermore, the return spring within the cartridge can sometimes catch hold of certain articles for insertion into the cartridge, e.g. coins. In addition, the diameter of the filler opening is significantly smaller than the inside diameter of the cartridge, thus limiting the volume of articles that can be stored therein.

Thus, an object of the present invention is to provide a cartridge that is easy to make and that can be used very easily.

According to the invention, a pneumatic cartridge that is constituted by a cylinder provided with two endpieces includes at least one automatically-closing transfer device designed to disengage the opening completely; furthermore, the device is arranged at one of the ends of the cartridge.

This arrangement considerably simplifies manufacture of the cartridge and makes it possible to obtain a large filler opening, given its dimensions.

In addition, the automatically-closing transfer device is centered on the longitudinal axis of the cartridge.

This disposition makes it possible to automate filling cartridges with cash: the bottom portion of a change machine can penetrate through the automatically-closing transfer device and deliver cash directly into the inside volume of the cartridge.

In a preferred embodiment, the automatically-closing transfer device comprises a hatch pivotally mounted on a hinge, the hinge being provided with return means.

This arrangement makes it possible to enable cartridges to be filled with cash automatically in secure manner: when the bottom portion of a change machine is not in contact with the automatically-closing transfer device of the cartridge, the automatically-closing transfer device is closed and the cash cannot under any circumstances escape from the cartridge.

According to an additional characteristic, the said hatch can move only towards the inside of said cartridge.

In a variant of the invention, the device also opens automatically.

This disposition makes it possible to automate unloading cash from cartridges.

Preferably, a moving blocking member prevents the transfer device from moving.

In addition, since the transfer device has a hatch provided with a projection, the blocking member consists in a retractable finger that comes to bear against the projection.

When the cartridge is provided with a lid, it is desirable to arrange the transfer device on the lid.

In addition to the fact that the invention can be implemented merely by adapting a single portion of the cartridge, i.e. the lid, this disposition makes it possible to work manually should that be necessary, whether for inserting cash or recovering it.

The present invention appears in greater detail from the following description of embodiments given by way of illustration and with reference to the accompanying drawings, in which:

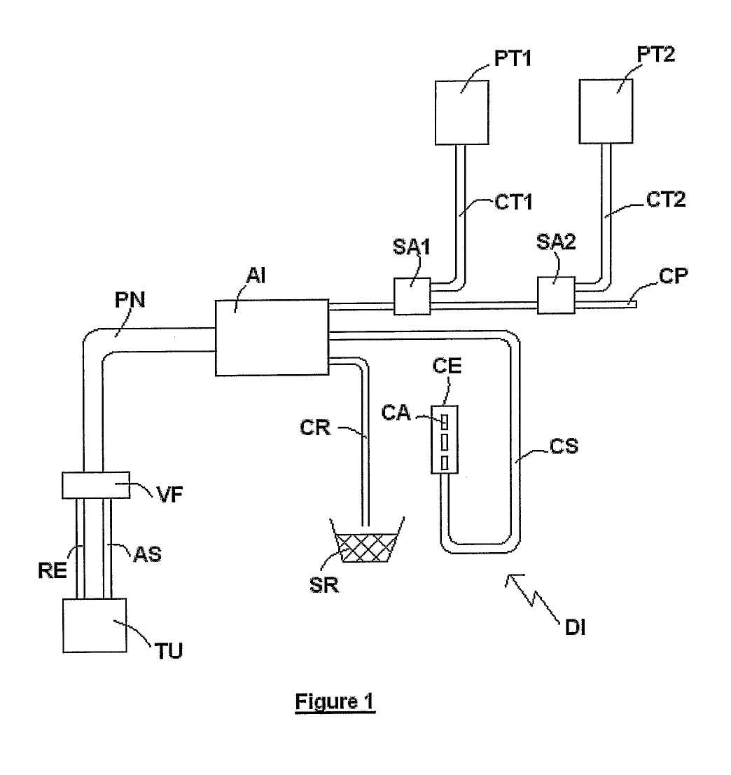

FIG. 1 shows a pneumatic network for conveying cartridges;

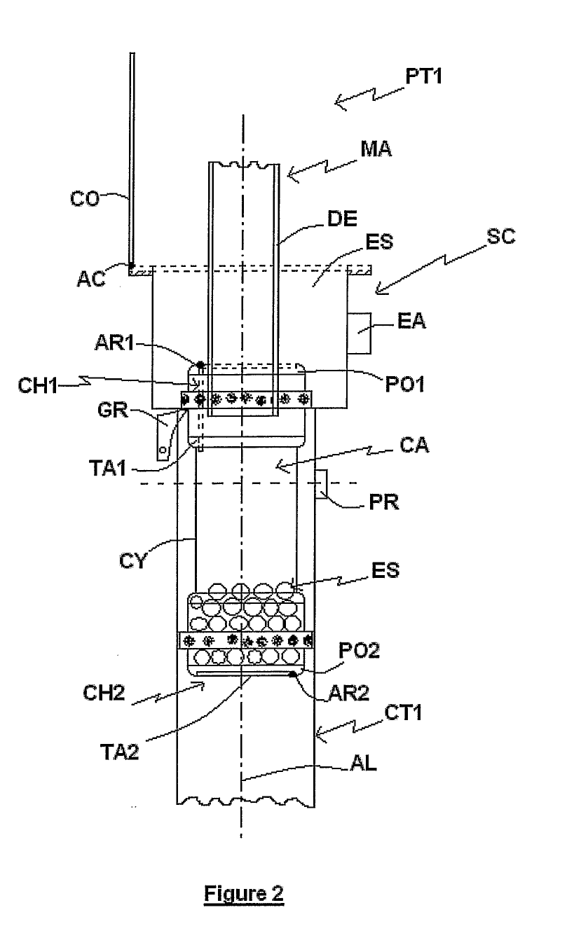

FIG. 2 is a section view showing a cartridge being loaded at the loading station of a workstation;

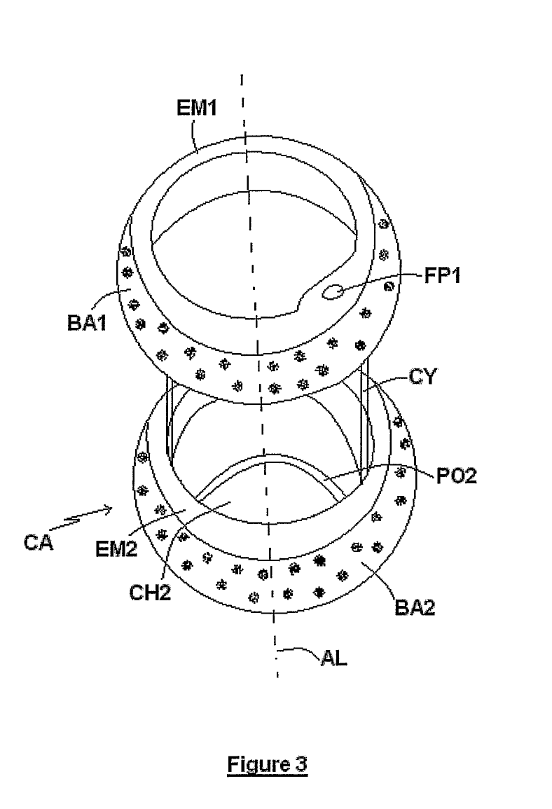

FIG. 3 is an overall view of a cartridge without a top lid or without an automatically-closing transfer device;

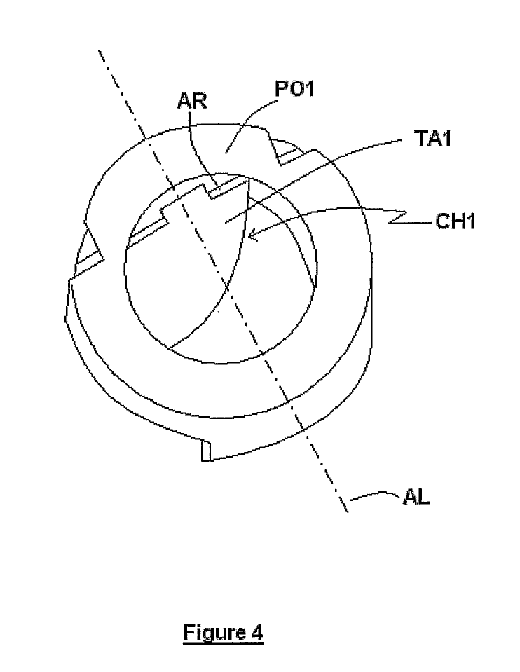

FIG. 4 is an overall view of a top lid and automatically-closing transfer device for a cartridge; and

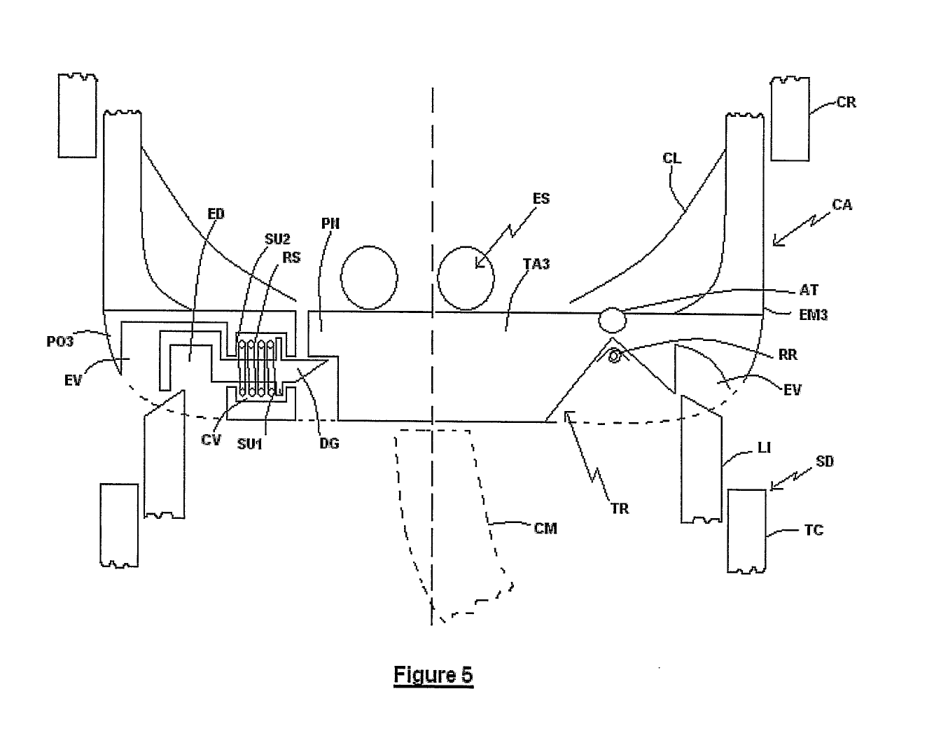

FIG. 5 is a section view through the bottom of a cartridge being unloaded at the unloading station of a surrender station.

Elements present in more than one of the figures are given the same reference in each of them.

A cartridge conveyor network DI is shown in FIG. 1. The network DI may be installed, for example, at a highway toll. It comprises a certain number of workstations PT1, PT2 occupied by toll collectors who collect money paid by users of the highway. These stations are connected by work pipes CT1, CT2 to a main pipe CP via secondary switchers SA1, SA2. The main pipe CP is also connected to a main switcher AI.

The network DI also has a secure surrender station SR. The surrender station SR is possibly located in an armored strong room for storing the money that comes from the workstations PT1, PT2 whenever cartridges CA arrive. It is connected via a surrender pipe CR to the main switcher AI.

The network DI also has a storage center CE enabling empty cartridges CA to be received and sent. The storage center CE is connected by a storage pipe CS to the main switcher AI. It serves to supply the workstations PT1, PT2 with cartridges CA.

The air pressure in the pipes can be decreased or increased with the help of a flow-varying unit VF connected firstly to a turbine TU and secondly to the switcher AI via a drive pipe PN.

When the turbine TU is used for compressing the air contained in the pipes, the air travels along a delivery pipe RE between the turbine TU and the flow-varying unit VF. It reaches the network via the drive pipe PN.

When the turbine TU is used for reducing the pressure of the air contained in the pipes, air is sucked from the network via the drive pipe PN. It follows a suction pipe AS between the flow-varying unit VF and the turbine TU.

Air exhausts (not shown) enable air to be exhausted or admitted at the ends of the various pipes, should that be necessary.

When a toll collector seeks to transfer a cartridge CA containing cash, he or she actuates a send control.

Initially, the network is at reduced pressure, and the cartridge is sucked from the workstation PT1 towards the main switcher AI. The suction downstream from the cartridge is compensated by admitting air through the exhaust provided at the end of the work pipe CT1. The main switcher AI is in the form of a rotary cylinder barrel in which each cylindrical chamber can be positioned at will in line with each pipe connected to the main switcher AI. This makes it possible to transfer a cartridge CA from one pipe to another, merely by turning the barrel, while allowing air to pass.

Thereafter, the network is pressurized and the cartridge is blown from the main switcher AI towards the surrender station SR. Excess upstream air is exhausted via the air exhaust arranged at the end of the surrender pipe CR.

The cartridge CA is then either emptied of its contents, or else placed in a secure location in order to be emptied subsequently.

In analogous manner, empty cartridges CA can be conveyed in two stages from the storage center CE towards the workstation PT1 by transisting through the main switcher AI.

Similarly, empty cartridges CA can be taken in two stages from the surrender station SR to the storage center CE by passing through the main switcher AI.

Such a network is dimensioned so as to enable exchanges to take place regularly with a set of workstations PT1, PT2, both concerning the number of cartridges CA required and concerning the air flow rate required for conveying the cartridges CA.

A cartridge CA is shown in FIG. 3.

It comprises a hollow cylinder CY of longitudinal axis AL made of a transparent plastics material, with each end being closed by an endpiece EM1, EM2 supporting an access lid PO2. The lid of the top endpiece EM1 is not shown. This lid pivots about an axis FP1 embodied by a pin or a screw secured to a return spring and coinciding with a generator line of the cylinder CY. It moves in a plane perpendicular to the longitudinal axis AL and it is designed to completely disengage the opening of the cylinder CY. Its seat is constituted by a bearing cornice formed in the thickness of the facing portion of the endpiece EM1, EM2.

Each endpiece EM1, EM2 is surrounded by a sliding band BA1, BA2 that comes into contact with the inside walls of the pipes and that makes it easier for the cartridge CA to pass therealong.

The diameter of the cylinder CY is smaller than that of the two endpieces EM1, EM2 so as to make it easier to go round bends in the pipes.

It is not possible for the lid PO2 to be opened accidentally while the cartridge CA is in a pipe since it is practically in contact with the inside wall of the pipe.

A lid PO1 provided with an automatically-closing transfer device CH1 is shown in FIG. 4. The device is in the form of a hatch TA1 mounted on a hinge AR. The hatch TA1 is of dimensions smaller than those of the lid PO1. It can be moved down towards the inside of the cartridge CA under the effect of a force exerted from the outside. In the absence of such a force, the hatch TA1 remains pressed against its seat under drive from a return spring RR mounted on the hinge axis AR. The seat is constituted by a plane bearing cornice formed in the bottom portion of the lid PO1. This configuration makes it absolutely impossible for the hatch TA to move towards the outside of the cartridge CA, and also makes it impossible for any article that is to be found inside the cartridge CA to escape. The return spring RR opposes the hatch TA1 remaining open or ajar towards the inside of the cartridge CA.

Such an automatically-closing transfer device CH1, CH2 can be disposed on each of the lids PO1, PO2, thus enabling the users of the network DI to pay no attention to the direction in which a cartridge CA is oriented.

In another embodiment (not shown), the automatically-closing transfer device CH1, CH2 can be placed on the cylinder CY of the cartridge CA.

A loading station SC of a workstation and a cartridge CA are shown in section in FIG. 2.

The cartridge CA is located at the top of a work pipe CT1. It is in contact with this pipe via the two slide bands BA1, BA2 disposed on its endpieces EM1, EM2. It is held in position by a blocking system such as a claw GR. The top of the work pipe CT1 opens out into a top space ES defined by a flap CO movable about an axis AC. The flap can be closed when there is no cartridge. An air exhaust EA allows excess air to be exhausted, when necessary, or conversely allows a certain quantity of air to enter.

While working, the toll collector collects cash from users and returns change. The cash is put into a receptacle, or it is inserted into a change machine. For reasons of safety, it is important not to retain too much cash in the workstation PT1, PT2. At regular intervals, cash must therefore be removed. If the cash is inserted into a change machine, it is easy to arrange for the bottom portion thereof to overlie the top space ES and thus deliver cash at will.

The bottom portion of the change machine, or spout, DE is in the form of a vertical tube extending a funnel. Its outside diameter is slightly smaller than the diameter of the hatch TA1. The spout DE can be moved vertically. It can therefore be lowered to press against the hatch TA1, which moves down by pivoting about its hinge AR1. The cash can then drop directly into the cartridge CA. A presence sensor PR situated in register with the cylinder CY enables filling to be stopped.

Conversely, when the spout DE rises, the hatch TA1 pivots about its hinge AR1 under drive from the return spring RR until it is pressed against its seat. The cash cannot escape from the cartridge CA.

In another embodiment (not shown), it is also possible to devise a spout DE that is stationary. The cartridge CA reaches the end of the work pipe CT1 at a certain speed and strikes the bottom of the spout DE. Continued advance of the cartridge causes the hatch TA1 to open. The cartridge CA slows down and reaches a stop position that causes the blocking claw GR to be activated, and that corresponds to the hatch TA1 being fully open.

Conversely, launching the departure procedure for a cartridge CA gives rise simultaneously to the blocking claw GR being deactivated, to the cartridge CA dropping, and to it being sucked towards the main pipe CP. The automatic closure of the hatch TA1 coincides with the departure of the cartridge CA, and thus to it becoming disengaged from the bottom of the spout DE.

When the cartridge CA is provided with two automatically-closing transfer devices CH1, CH2, it can be used equally well either way round.

Using such cartridges CA within a pneumatic network DI for conveying cartridges is made that much easier in that it requires no modification to the network DI.

It should be specified that the invention is well adapted to automating procedures for loading cartridges.

Numerous other embodiments of the automatically-opening transfer device can be envisaged. Firstly a cone of elastic material can be devised having a cut end located inside the cylinder CY and its opposite end bonded to one of the endpieces EM1, EM2 of the cartridge CA. It is also possible to have recourse to a motor-driven system.

The description above relates to loading the cartridge CA. In another embodiment of the invention, it is also possible to implement an automatically-closing transfer device CH1, CH2.

An unloading station SD in the surrender station SR together with the bottom portion of a cartridge CA are shown in section in FIG. 5. The cartridge CA reaches the unloading station SD via a surrender pipe CR and drops vertically onto a release member LI axially in alignment with the end of said pipe CR. This member is in the form of an annular collar with a chamfered top. It is placed at the top of a collector tube TC that is likewise vertical. The tube leads to a cash-collecting receptacle. The cartridge CA is blocked in position by claws (not shown).

The lid PO3 of the cartridge CA is provided with a new transfer device CH3 that likewise has a hatch TA3 mounted on a hinge AT. The hatch TA3 is of dimensions smaller than the dimensions of the lid PO3. It can penetrate towards the inside of the cartridge CA under the effect of a force exerted from the outside. In the absence of such a force, the hatch TA3 remains in the closed position under drive from a return spring RR mounted on the hinge axis AT. A blocking member DG is designed to hold the hatch TA3 stationary and is secured to the lid PO3. In this example it is in the form of a retractable finger. In the closed position, this finger blocks a projection PN arranged at the end of the hatch TA3 so as to make it impossible for the hatch TA3 to move towards the outside of the cartridge CA.

The retractable finger DG is arranged radially in a cylindrical cavity CV placed in the thickness of the endpiece EM3. This cavity is of a shape such as to allow the finger to move radially. It is provided in particular with an orifice at each of its ends such that the finger can move along a certain stroke. The finger is held in the closed position under drive from a cylindrical spring RS working in compression. Firstly, the spring RS bears against an annular shoulder SU1 of the finger DG. In the closed position, the shoulder SU1 comes into abutment against the first end of the cavity facing the hatch TA3. Secondly, the spring RS bears against the inside face SU2 of the second end of the cavity CV.

The outside section EP of the finger projects outwards from the second end of the cavity CV and extends into a circular recess EV formed at the periphery of the endpiece EM1. It is in the form of a hook ED.

When the cartridge CA is held in place by the claws and the endpiece EM3 is in contact with the release member LI, the release member penetrates into the hook ED. Since the release member is chamfered, it presses sideways against the inside edge of the hook ED, thus causing the finger DG to be withdrawn towards the first end of the cavity CV, thereby releasing the projection PN from the hatch TA3. The hatch then pivots about the hinge AT towards the outside under drive from the return spring RR.

As a result, the coins drop into the receptacle of the unloading station SD. To ensure that some coins do not remain jammed in the cartridge CA, the cartridge is preferably provided with an internal partition CL forming a funnel leading to the hatch TA3.

The release member LI is then disengaged from the cartridge CA, thus allowing the finger DG to return to its closed position.

The hatch TA3 is closed by a plurality of presser calipers CM in the form of metal circular arcs secured to the ends of bars hinged to the outside face of the collector tube TC. These calipers are movable in a vertical plane. They can pivot and pass through the collector tube TC via suitable orifices. Whatever the angular position of the cartridge CA, one of the presser calipers will come into contact with the open hatch TA3, push against it, and follow its pivoting until it reaches the closed position.

Since the face of the finger DG that comes into contact with the projection PN is chamfered, the force exerted thereby pushes the finger away sideways so as to allow the hatch TA3 to reach the closed position. The finger DG returns to its locking position and the calipers CM can be disengaged from the collector tube TC.

It is appropriate to specify once more than the operation of emptying the cartridge can be entirely automatic.

This embodiment is given purely by way of indication amongst numerous existing mechanical configurations. In particular, it is possible to couple the actions of the release member LI and of the calipers CM of the collector tube TC, even though they are described as being separate herein.

The embodiments of the invention described above have been selected because of their concrete nature. Nevertheless, it is not possible to list exhaustively all embodiments covered by the invention. In particular, any of the means described could be replaced by equivalent means without going beyond the ambit of the present invention.

1. A pneumatic cartridge CA constituted by a cylinder CY provided with two endpieces EM1, EM2 and including at least one opening, the cartridge having at least one automatically-closing transfer device CH1, CH2, TR provided for completely disengaging said opening, and being characterized in that said automatically-closing transfer device is arranged at one of its ends.

2. A cartridge according to claim 1, characterized in that said automatically-closing transfer device CH1, CH2, TR is centered on its longitudinal axis AL.

3. A cartridge according to claim 2, characterized in that said automatically-closing transfer device CH1, CH2, TR comprises a hatch TA1, TA2, TA3 pivotally mounted on a hinge AR, AT, said hinge AR, AT being provided with return means.

4. A cartridge according to claim 3, characterized in that said hatch TA1, TA2 can move solely towards the inside of said cartridge CA.

5. A cartridge according to any one of claims 1 to 3, characterized in that said transfer device TR opens automatically.

6. A cartridge according to claim 5, characterized in that it includes a movable blocking member DG for preventing said transfer device from moving.

7. A cartridge according to claim 6, characterized in that said transfer device includes a hatch TA3 provided with a projection PN, and said blocking member consists in a retractable finger DG coming to bear against said projection.

8. A cartridge according to any preceding claim, characterized in that the device is provided with at least one lid PO1, PO2, and said transfer device CH1, CH2, TR is arranged on the lid PO1, PO2.
